(19) United States
(12) Patent Application Publication
(10) Pub. No.: US 2026/0205988 A1
(43) Pub. Date: Jul. 16, 2026

(54) ENABLING USER EQUIPMENT TO CONNECT TO NON-PUBLIC MOBILE NETWORK

(71) Applicants: Koninklijke KPN N.V., Rotterdam (NL); Nederlandse Organisatie Voor Toegepast-Natuurwetenschappelijk Onderzoek TNO, 's-Gravenhage (NL)

(72) Inventors: Belma Turkovic, Delft (NL); Lucia D'Acunto, Amsterdam (NL)

(21) Appl. No.: 19/137,611

(22) PCT Filed: Dec. 9, 2023
(86) PCT No.: PCT/EP2023/085006

§ 371 Date: Jun. 10, 2025

(30) Foreign Application Priority Data
Dec. 23, 2022 (EP) 22216628

(51) Int. Cl. H04W 64/00; H04W 24/08; H04W 76/10

(52) U.S. Cl. CPC H04W 64/00; H04W 24/08; H04W 76/10

(57) ABSTRACT

A device, system and methods are described to enable the device, which may represent user equipment for a mobile network, to make use of a non-public mobile network which may be available at one or more locations. The device may be provided with location information which identifies the locations at which the non-public mobile network is available and with frequency information for at least one of the one or more locations. The device may be configured to use the location information to determine if the device is at or within a vicinity of one of the locations, and if so, perform measurements at radio frequencies indicated by the frequency information. As the coverage area of the non-public network may be relatively sparse, this may avoid the inefficiencies of a continuous or periodic search for non-public networks, which may otherwise place a burden on compute, battery and/or radio resources of the UE.

### TECHNICAL FIELD

The invention relates to a device representing user equipment for a mobile network and to a computer-implemented method performed by the device. The invention further relates to a system configured to enable user equipment to connect to a non-public mobile network and to a computer-implemented method performed by the system. The invention further relates to a computer-readable medium comprising data for causing a processor system to perform any of the computer-implemented methods.

### BACKGROUND

Recent telecommunication standards provide support for non-public mobile networks, which may also simply be referred to as non-public networks (NPN). A typical example of a non-public network is a private network. In general, non-public networks may take various forms, such as a standalone non-public mobile network (SNPN), referring to a non-public network that is operated by a NPN operator and not relying on network functions provided by a public land mobile network (PLMN), or a public network integrated non-public network (PNI-NPN), referring to a non-public network which may be deployed with the support of a public network.

Non-public networks may offer advantages to operators and users alike. For example, for an enterprise, a non-public network may allow the enterprise to provide employees with enterprise-specific services and to ensure the confidentiality of the data which is transmitted through the network. Another example is that for an organizer of an event, a non-public network may allow the organizer to provide event-specific services, such as access to high-quality streams of all camera viewpoints recording the event, and to provide additional coverage to attendees of the event.

However, to be able to use the services or additional coverage provided by a non-public network, such as that operated by or on behalf of an enterprise, user equipment (UE) may need to switch to the non-public network when the UE is in the coverage area of the non-public network. However, an operator of a non-public network should not depend on users searching for the non-public network using their device and manually switching their device to the non-public network. For example, for an enterprise, requiring employees to manually switch to the enterprise network may cause operational overhead and/or may cause the users to forget to switch or not know how to switch. In addition, a manual switch may not be possible (or may at least be very cumbersome) for UE other than mobile phones, such as connectivity-enabled vehicles or other IoT devices, as these UE may lack an easily accessible user interface. These problems may be even more pronounced for a UE that changes location often, e.g., when driving between multiple of the enterprise's locations on a daily basis. Finally, employees may need to switch back to the public mobile network upon leaving the enterprise's premises to ensure continued connectivity, which again causes an operational overhead and/or may cause the users to forget to switch back.

One of the reasons that UE may not automatically search for non-public mobile networks may be that only a limited number of non-public mobile networks may be of relevance for any given UE, for example only the enterprise's networks, and the coverage area of a non-public mobile network may be limited, which means that a continuous or periodic search for non-public mobile networks may be inefficient, e.g., placing a burden on compute, battery and/or radio resources of the user equipment. Furthermore, a public mobile network typically provides good coverage at the location of the non-public mobile network, which means that it may not be possible to rely on the same triggers which otherwise may trigger a UE to search for another public mobile network, e.g., the UE leaving the coverage area of the public mobile network.

### SUMMARY

It may be desirable for a device representing user equipment of a mobile network to be able to switch to a non-public mobile network without a need for users to manually search for and switch to the non-public mobile network using the device and without a need to continuously search for non-public mobile networks.

In a first aspect of the invention, a device is provided which may represent user equipment for a mobile network. The device may comprise:
a radio access network interface;
a processor subsystem which may be configured to:
   receive location information which may identify one or more locations at which a non-public mobile network is available;
   receive frequency information for at least one of the one or more locations, wherein the frequency information for a location may be indicative of one or more radio frequencies used by the non-public mobile network at the location;
wherein the processor subsystem may be further configured to:
   using the location information, determine if the device is at or within a vicinity of the location; and
   if the device is at or within the vicinity of the location, perform measurements at the one or more radio frequencies indicated by the frequency information to enable the device to connect to the non-public mobile network if the measurements indicate that a connection to the non-public mobile network is possible.

In a further aspect of the invention, a system is provided which may be configured to enable user equipment to connect to a non-public mobile network, wherein the system may be part of the non-public mobile network. The system may comprise:
a network interface;
a processor subsystem configured to, via the network interface:
   send location information to the user equipment, wherein the location information may identify one or more locations at which the non-public mobile network is available; and
send frequency information for at least one of the one or more locations to the user equipment, wherein the frequency information for a location may be indicative of one or more radio frequencies used by the non-public mobile network at the location.

In a further aspect of the invention, a computer-implemented method is provided for being performed by a device which represents user equipment for a mobile network. The method may comprise, by the device:
receiving location information which may identify one or more locations at which a non-public mobile network is available;
receiving frequency information for at least one of the one or more locations, wherein the frequency information for a location may be indicative of one or more radio frequencies used by the non-public mobile network at the location;
using the location information, determining if the device is at or within a vicinity of the location; and
if the device is at or within the vicinity of the location, performing measurements at the one or more radio frequencies indicated by the frequency information to enable the device to connect to the non-public mobile network if the measurements indicate that a connection to the non-public mobile network is possible.

In a further aspect of the invention, a computer-implemented method is provided for enabling user equipment to connect to a non-public mobile network. The method may comprise, by a system which is part of the non-public mobile network:
sending location information to the user equipment, wherein the location information may identify one or more locations at which the non-public mobile network is available; and
sending frequency information for at least one of the one or more locations to the user equipment, wherein the frequency information for a location may be indicative of one or more radio frequencies used by the non-public mobile network at the location.

In a further aspect of the invention, a transitory or non-transitory computer-readable medium may be provided comprising data representing a computer program, the computer program comprising instructions for causing a processor system to perform any of the computer-implemented methods as described in this specification.

The above measures may relate to the following. A non-public mobile network, which is in the following simply referred to as a non-public network, may be available at one or more geographical locations. For example, a non-public network operated on or on behalf of an enterprise may be available at several of the enterprise's locations, while such locations may be spaced apart from each other, e.g., different districts of a city or different cities, regions, and/or countries. The UE, meaning one or each of a plurality of UE, may be provisioned to use the non-public network at these locations, but may typically also be configured to use a public network since the coverage area of the non-public network may be limited to only these locations while not providing coverage outside of these locations. For example, the UE may be a subscriber to a public mobile network or allowed to roam over a public mobile network.

To enable the UE to connect to the non-public network where it is available, e.g., at the respective location(s), location information may be provided to the UE which may identify the location(s) of the non-public network to the UE. Such location information may directly pertain to the non-public network, for example, by indicating a location of a base station(s) of the non-public network at a respective location or by indicating the approximate coverage area of the non-public network at a respective location. However, the location information may also indirectly pertain to the non-public network, in that the location information may identify a location of an enterprise, venue, event, etc. at which the non-public network is available. A specific example is that of a non-public network which may be operated on or on behalf of an enterprise, in which case the location information may identify locations of the enterprise at which the non-public network is available, for example by indicating a central point on the enterprise's premises or by identifying the approximate extent of the enterprise's premises.

In addition to the location information, frequency information may be provided to the UE. The frequency information may identify the radio frequency or radio frequencies at which the base station(s) of the non-public mobile network at a respective location operate. This may enable the UE to perform measurements at these radio frequencies, with such measurements being a known prerequisite for the UE to be able to connect to the mobile network operating at the radio frequencies. Namely, on the basis of the results of the measurements, it may be determined whether the UE is in actual range of the non-public network or not, and if it is within range, the UE may switch and connect to the non-public network, for example, based on internal decision logic which may implement a so-called switching procedure.

The combination of location information and frequency information may enable the UE to selectively perform the measurements to search for the non-public mobile network. This selectivity may be two-fold, as it may be selective in terms of location and selective in terms of radio frequency. Namely, the measurements may be performed only if the UE is at or in vicinity of a location of the non-public network. Whether or not this is the case may be determined by comparing a current location of the UE, e.g., as determined by GPS or triangulation of wireless networks, to the location(s) of the non-public network as identified in the location information. In addition, the measurements may be performed out at the specified radio frequency(-ies), rather than at all radio frequencies at which measurements may be performed.

The location information and frequency information may be provided to the UE by a system which may be part of the non-public mobile network. For example, the location information and frequency information may be provided during a so-called provisioning procedure while the UE is connected to the non-public mobile network or via a public mobile network through which the non-public mobile network is reachable.

The above measures may have the effect that instead of continuously or periodically searching for the non-public network, the device may conditionally search for the non-public network, namely only if the device is at or within the vicinity of a location at which the non-public network is available. If the device is at or within the vicinity of the location, measurements at the one or more radio frequencies indicated by the frequency information may be performed, which measurements may be known per se. This may have the following advantages. As the coverage area of the non-public network may be relatively sparse, this may avoid the inefficiencies of a continuous or periodic search for non-public networks, which may otherwise place a burden on compute, battery and/or radio resources of the UE. In addition, by way of the frequency information, the UE may be instructed to listen specifically at the radio frequencies of the non-public network and to consider the found non-public network as a candidate network to connect to, which it otherwise may not do. This means that the UE may not have to search on all radio frequencies, which may also further prolong the UE's battery life and may speed up the searching process. The above measures thus enable a UE to find a non-public network operating at specific radio frequencies and at one or more specific locations without a need for the UE to indiscriminately, e.g., in terms of location and radio frequencies, search for the non-public mobile network.

The following embodiments may relate to the device representing user equipment and the computer-implemented method performed by the device but may denote corresponding limitations of the system which is part of the non-public mobile network and the computer-implemented method performed by the system.

In an embodiment, the processor subsystem may be configured to, after receiving the location information, request the frequency information from an entity within the non-public mobile network. The frequency information may be obtained separately from the location information by the UE, for example, at a later moment in time. This may reflect the order of steps performed at the UE where the UE may first use the location information to determine whether it is at or in vicinity of a location and only then perform the measurements at the radio frequency(-ies) specified by the frequency information. By supplying the information to the UE in the same order, the frequency information may be supplied later, which means that it may be more up-to-date and may not need to be stored in the UE for a prolonged period. For example, only the most recently received frequency information may be stored, or the received frequency information may not be stored at all in a persistent data storage but may rather only temporarily be stored in a volatile data storage of the UE, e.g., in memory.

In an embodiment, the processor subsystem may be configured to request the frequency information if the device is, or is expected to be, at or within the vicinity of the location. The frequency information for a particular location may be requested by the UE if the UE is, or is expected to be, at or within the vicinity of the location. This way, it is not needed for the UE to rely on previously stored frequency information, which may be out-of-date when the UE visits a particular location, nor for the UE to store the frequency information for a prolonged period, which may unnecessarily allocate space in the UE's local data storage or on the UE's sim card. For example, only the most recently received frequency information may be stored, or the received frequency information may not be stored at all in a persistent data storage but may rather only temporarily be stored in a volatile data storage of the UE, e.g., in memory

In an embodiment, the processor subsystem may be configured to request the location information from an entity within the non-public mobile network. This entity may be elsewhere described as a “system configured to enable user equipment to connect to a non-public mobile network” or as the functionality of the non-public network. By being configured to request the location information, the UE may be in control of the moment in time when the location information is requested and may thereby request the location information at a moment in time when the UE needs it, for example, when previously stored location information has become outdated or less relevant, for example if the previously stored location information pertains to locations which are far away from the current location of the UE.

In an embodiment, the processor subsystem may be configured to include at least one geolocation in the request for the location information, wherein the least one geolocation may comprise at least one of:
a current geolocation of the device;
an expected geolocation of the device; and
a combination of the current geolocation or the planned geolocation of the device and one or more geolocations which may be selected by the processor subsystem not to represent a geolocation of the device, for example, one or more pseudo-randomly selected geolocations.

By including a geolocation in the request for location information, the entity providing the location information may be enabled to provide location information for relevant locations of the non-public network, for example, for locations which are nearby the indicated geolocation(s). By providing the current geolocation, the UE may obtain location information for nearby locations. By providing an expected geolocation, for example, one that is planned to be visited, the UE may obtain location information for location(s) in advance. By providing the current geolocation as well as one or more geolocations which do not represent the current geolocation of the UE, e.g., by being randomly selected, some degree of privacy may be offered as the entity supplying the location information may not be able to determine the exact geolocation of the UE, except for that the UE is likely to be at one of the indicated geolocations but without knowing the exact geolocation.

In an embodiment, the processor subsystem may be configured not to include a geolocation in the request for the location information. This way, the geolocation of the device may not be revealed to the entity supplying the location information, which may be advantageous in terms of ensuring privacy.

In an embodiment, the processor subsystem may be configured to indicate, in the request for the location information, how many locations of the non-public mobile network, which are nearest to a respective geolocation from the request for the location information, are to be identified in the location information. The UE may thus be enabled to request location information for a specific number of locations, which may be advantageous since the device may adapt this number to account for, for example, the available storage capacity in the UE's data storage or the UE's sim card.

In an embodiment, the processor subsystem may be configured to determine whether the device is outside a range of the one or more locations identified in the location information, and if it is determined that the device is outside the range, request further location information of one or more further locations of the non-public mobile network, for example, which may be nearer to the device. Some non-public networks may have many locations, in which case it may not be preferred to store the location information for all locations in the UE at the same time. By only storing the location information for a limited number of locations, but by being able to replace the location information of locations which are distant to the UE with location information of locations which may be nearer to the UE, the location information may nevertheless be kept relevant to the UE as the location information stored by the UE may be kept up-to-date to include nearby locations which the UE may be most likely to visit.

In an embodiment, the processor subsystem may be configured to receive the location information, receive the frequency information, and/or send respective requests to an entity within the non-public mobile network, via a public mobile network. While the UE may receive the location information and the frequency information when the UE is connected to the non-public network, for example, during an initial provisioning procedure or during any later moment in time when the UE is at a location of the non-public network, the UE may not be continuously connected to the non-public network. By being able to receive the location information and the frequency information via a public network, the UE may be provided with this information and updates to this information even if it is not connected to the non-public network.

In an embodiment, the processor subsystem may be configured to receive the location information, and/or send respective requests to an entity within the non-public mobile network, via the non-public mobile network.

The following embodiments may relate to the system which is part of the non-public mobile network and the computer-implemented method performed by the system but may also denote corresponding limitations of the device representing user equipment and the computer-implemented method performed by the device.

In an embodiment, the processor subsystem may be configured to send the frequency information to the user equipment in response to a request for the frequency information which is received from the user equipment. The frequency information may be provided separately from the location information to the UE, for example, at a later moment in time. This may reflect the order of steps performed at the UE, where the UE may first use the location information to determine whether it is at or in the vicinity of a location and only then perform the measurements at the radio frequency(-ies) specified by the frequency information. By supplying the information to the UE in the same order, the frequency information may be supplied later, which means that it may be more up-to-date and may not need to be stored in the UE for a prolonged period.

In an embodiment, the location information may identify a plurality of locations of the non-public mobile network, wherein the request for the frequency information may identify one or a subset of the plurality of locations, and wherein the processor subsystem may be configured to selectively send the frequency information for the one or the subset of locations. The frequency information for a particular location may be provided to the UE if the UE is, or is expected to be, at or within the vicinity of the location. By the request identifying the location, the frequency information for this location may be provided to the UE. This way, it is not needed for the UE to rely on previously stored frequency information, which may be out-of-date when the UE visits a particular location, nor for the UE to store the frequency information for a prolonged period, which may unnecessarily allocate space in the UE's local data storage or on the UE's sim card.

In an embodiment, the processor subsystem may be configured to send the location information to the user equipment in response to a request for the location information which is received from the user equipment.

In an embodiment, the request for the location information may comprise at least one geolocation, and wherein the processor subsystem may be configured to send the location information for one or more locations of the non-public mobile network, wherein the one or more locations may be selected based on the at least one geolocation, for example, based on whether a respective location is within a vicinity of the at least one geolocation. By one or more geolocations being included in the request for location information, the system may provide location information for locations of the non-public mobile network which are presumed to be relevant to the UE, for example, for locations which are nearby the geolocation(s) indicated in the request.

In an embodiment, the location information may identify the location of the non-public mobile network by at least one of:
a geolocation defined by a latitude and a longitude;
a geographical area defined by a latitude, longitude, and radius;
a geographical area defined by a plurality of geolocations; and
an identifier of one or more base stations of the public network at the location of the non-public mobile network.

A geolocation defined by a latitude and longitude may define a geographical point and may serve as a coarse indication of the location at which the non-public network is available. An advantage of a geolocation defined by a latitude and longitude is that it requires little data storage. A geographical area defined by a latitude, longitude, and radius may provide an indication of the coverage area of the non-public network while requiring only modestly more data storage than a geolocation defined by a latitude and longitude. A geographical area defined by a plurality of geolocations may allow the coverage area of the non-public network to be more accurately indicated, which may enable the UE to better determine when to start measurements.

In an embodiment, the processor subsystem may be configured to send the location information and/or the frequency information to the user equipment via a public mobile network, for example via a non-3GPP Inter-Working Function (N3IWF) of the non-public mobile network.

In a further aspect of the invention, a mobile network is provided comprising the system as described above. In a further aspect of the invention, a mobile network is provided comprising the system and the user equipment as described above.

It will be appreciated by those skilled in the art that two or more of the above-mentioned embodiments, implementations, and/or aspects of the invention may be combined in any way deemed useful.

Modifications and variations of any one of the systems or devices (e.g., network nodes or systems of network nodes, network functions, user equipment, etc.), computer-implemented methods, and/or computer programs, which correspond to the described modifications and variations of another one of these systems or devices, computer-implemented methods, and/or computer programs, or vice versa, may be carried out by a person skilled in the art on the basis of the present description.

### BRIEF DESCRIPTION OF THE DRAWINGS

These and other aspects of the invention are apparent from and will be elucidated with reference to the embodiments described hereinafter. In the drawings,

FIG. 1 shows user equipment (UE) which are subscribers of a public land mobile network (PLMN) being in a coverage area of a non-public mobile network (NPN)

FIG. 2 shows a UE of the PLMN switching from the PLMN to the NPN;

FIG. 3 illustrates the registration of the UE with the NPN via a PDU session of the PLMN to the NPN;

FIG. 4 shows a handover of the UE's PDU session with the NPN from the non-3GPP access to the 3GPP access and handover of the UE's PDU session with the PLMN from the 3GPP access to the non-3GPP access;

FIG. 5 shows the redirection of the UE to the NPN, which involves a provisioning procedure and a switching procedure;

FIG. 6 shows a UE storing a location database and a gNB database;

FIG. 7 shows a UE storing a location database;

FIG. 8 shows a message exchange in a first provisioning procedure and a switching procedure;

FIG. 9 shows a message exchange upon a change in NPN topology;

FIG. 10 shows a message exchange in a second provisioning procedure;

FIG. 11 shows a message exchange in a switching procedure;

FIG. 12 shows a processor system which may be exemplary for a system or a UE as described in this specification;

FIG. 13 shows a non-transitory computer-readable medium comprising data;

FIG. 14 shows an exemplary data processing system.

It should be noted that items which have the same reference numbers in different figures, have the same structural features and the same functions, or are the same signals. Where the function and/or structure of such an item has been explained, there is no necessity for repeated explanation thereof in the detailed description.

### REFERENCE SIGNS LIST

The following list of references and abbreviations is provided for facilitating the interpretation of the drawings and shall not be construed as limiting the claims.
5GC 5G core
gNB gNodeB
NPN non-public mobile network
PLMN public land mobile network
SNPN standalone non-public mobile network
UE user equipment
1-67 messages/steps
100 PLMN 5G core
110 PLMN base station
200 SNPN 5G core
210 SNPN base station
220, 222 coverage area at enterprise location
300 user equipment
330 location database
340 gNB database
400 system
410 network interface
420 processor subsystem
430 data storage
500 non-transitory computer-readable medium
510 stored data
1000 exemplary data processing system
1002 processor
1004 memory element
1006 system bus
1008 local memory
1010 bulk storage device
1012 input device
1014 output device
1016 network adapter
1018 application

### DESCRIPTION OF EMBODIMENTS

The following embodiments are described in the context of a 5G telecommunications network adhering to one or more ETSI NFV and related standards. However, the concepts described in the following embodiments may equally apply, mutatis mutandis, to any other type of telecommunication standard which provides for public mobile networks and non-public mobile networks for user equipment.

For reasons of conciseness, the following may refer to public mobile networks simply as public networks or by the acronym PLMN, and to non-public mobile networks as non-public networks or private networks or by the acronym SNPN, which refers to the specific example of a standalone non-public network. However, this is not a limitation, as the claimed measures may equally apply to other types of non-public networks, such as public network integrated non-public networks (PNI-NPN).

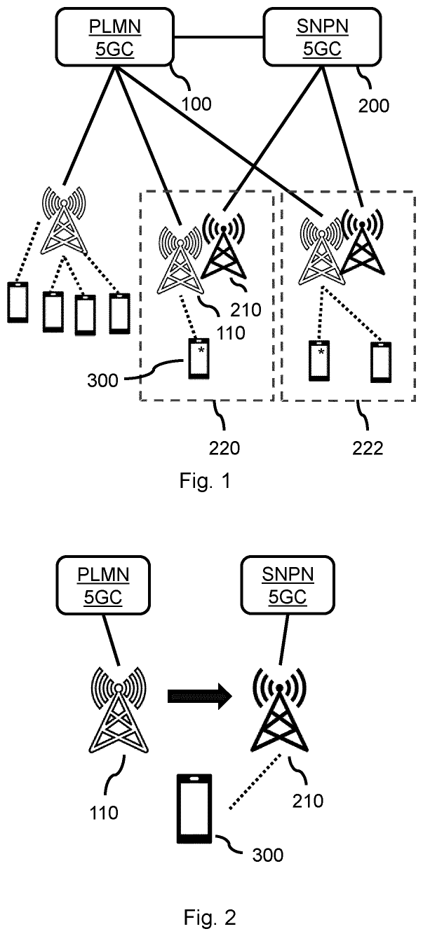

FIG. 1 shows user equipment UE 300 which is in a coverage area 220 of a standalone non-public mobile network SNPN. The SNPN is shown in FIG. 1 in the form of a network core 200 and one or more base stations 210. In the example of FIG. 1, the SNPN is shown to have base stations at two locations which are geographically spaced apart, for example, located in different cities, regions or even countries, to establish separate coverage areas. FIG. 1 shows an example in which a base station 210 at a first location may establish a first coverage area 220 of the SNPN and a base station at a second location may establish a second coverage area 222 of the SNPN. It will be appreciated, however, that the SNPN may also have more than one base station at a respective location. The network core 200 of the SNPN may be a 5G network core (‘5GC’), but may also be a later generation network core, e.g., 6^{th} generation or later.

FIG. 1 further shows a public land mobile network PLMN, which is also shown in the form of a 5G network core 100 and several base stations 110. In the example of FIG. 1, both coverage areas 220, 222 of the non-public network SNPN are shown to overlap with the coverage area of the public network, as in the example of FIG. 1, the PLMN includes base stations 110 in the coverage areas 220, 222 of the SNPN.

In the situation shown in FIG. 1, the UE 300 is connected to the PLMN via a base station 110 while being in the first coverage area 220 of the SNPN. Despite being connected to the PLMN, it may nevertheless be desirable for the UE 300 to connect to the SNPN. For example, the SNPN may be of an enterprise and the UE 300 may be a device of an employee. In such an example, it may be desirable to allow the UE 300 to connect to the SNPN, for example, to access internal documents, services, and resources while at the enterprise' premises. A SNPN may also provide other advantages to an enterprise and its UE, including but not limited to:
1. A local data plane, which may provide a degree of quality of service (QoS) required by the enterprise, such as a very low latency.
2. The possibility to process data within its premises. The enterprise may wish for data to be processed within its premises on the infrastructure owned and controlled by the enterprise, e.g., for confidentiality or security reasons.
3. The SNPN may offer specialized services to the enterprise's employees.

FIG. 2 illustrates a result of the UE 300 switching from the PLMN to the SNPN as the UE 300 is now connected to a base station 210 of the SNPN. A method for a UE to switch from a PLMN to a SNPN may be known per se. Namely, a user of a UE may search for the SNPN using the UE's user interface, for example by requesting the UE to show all available mobile networks, and manually instruct the UE to connect to the SNPN, for example, by selecting the SNPN from a list of found mobile networks. However, it would be desirable to enable UE at a particular location, such as an enterprise's premises, to be able to switch to an SNPN without a user having to manually search for the SNPN using the UE and then manually select the SNPN.

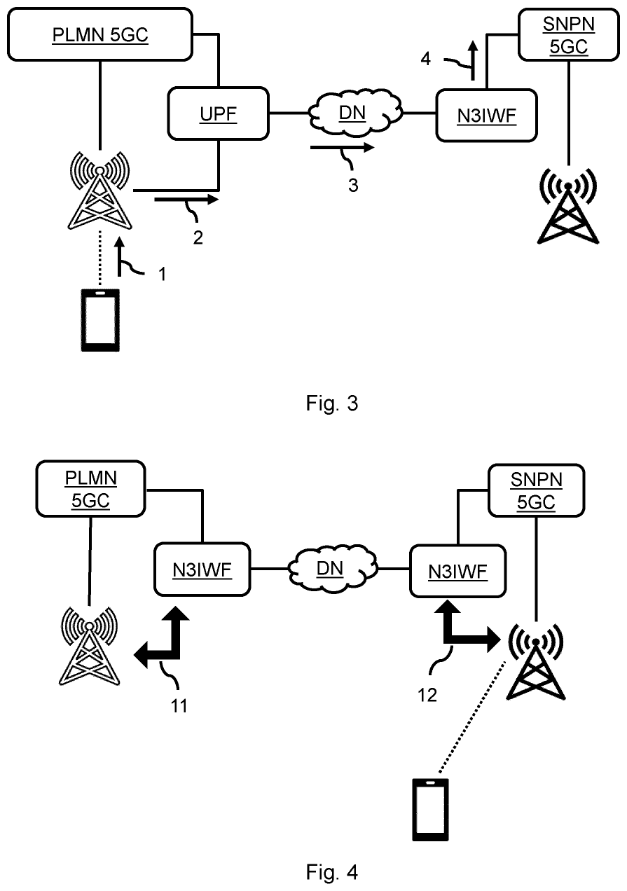

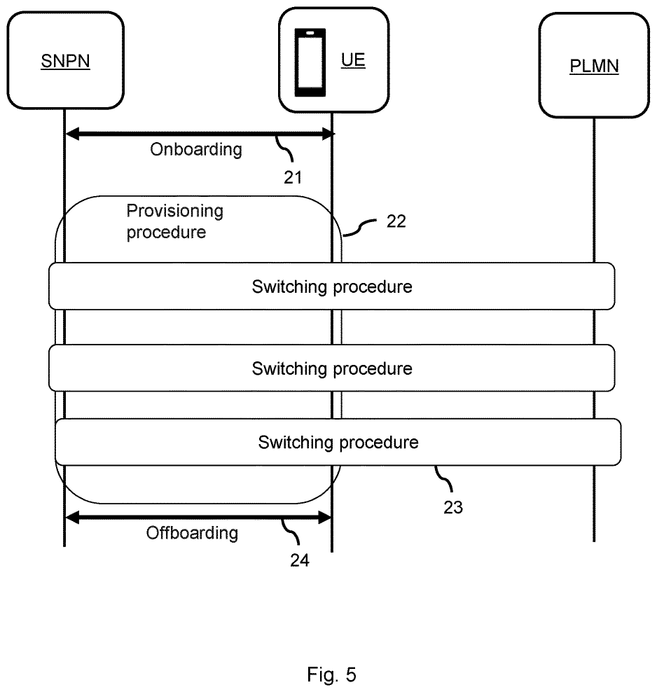

FIGS. 3, 4 illustrate that current 3GPP standards support so-called service continuity, which may be used in conjunction with the measures described with reference to FIGS. 5-11 to enable a UE to more seamlessly switch from a PLMN to an SNPN. It is noted, however, that use of service continuity is not per se required.

FIG. 3 illustrates the registration of the UE with the SNPN via a protocol data unit (PDU) session of the PLMN to the SNPN. This figure may be explained as follows. 3GPP standards support a simultaneous registration of a UE to both a SNPN and a PLMN. This simultaneous registration may involve the UE first registering with one of the networks, e.g., the PLMN in the example of FIG. 3. The UE may then register with the other network, e.g., the SNPN, via the SNPNs non-3GPP inter-working function (N3IWF) over the PDU session of the PLMN. This registration with the SNPN may involve an initial message being sent by the UE to the SNPN via the steps 1-4 shown in FIG. 3, e.g., step 1. being the message being sent by the UE via the PLMN's base station, 2. to a PLMN's user plane function (UPF), and 3. via a data network (DN) to the SNPN's N3IWF, and 4. from the N3IWF to the SNPN's 5G network core. In this registration, the PLMN may take the role of an “untrusted non-3GPP access” node to the SNPN. This may enable PDU session continuity of both the PDU sessions of the UE in the PLMN and in the SNPN when switching the radio access node from the PLMN's base station (e.g., gNodeB, in the following also simply referred to as gNB) to the SNPN's base station.

FIG. 4 shows a handover 12 of the UE's PDU session with the NPN from the non-3GPP access to the 3GPP access and handover 11 of the UE's PDU session with the PLMN from the 3GPP access to the non-3GPP access. This may involve executing procedures for a “Handover of a PDU Session procedure between 3GPP and untrusted non-3GPP access” as defined in clause 4.9.2 of 3GPP TS 23.502.

With continued reference to enabling a UE to switch to an SNPN without a need for manual search and selection by a user, the following is noted. When searching for a mobile network to connect to, a UE may generally be configured to operate in one of two modes: (1) a PLMN access mode or (2) a SNPN access mode. However, in the PLMN mode, a UE may only search for available PLMNs within range. Conversely, when in the SNPN mode, a UE may only search for available SNPNs within range. The UE may generally be unaware of when to switch access mode and search for SNPNs. This may especially apply when the UE is connected to the PLMN, as a PLMN typically provides good coverage and typically will not cause connected UE to search for other networks for reasons of poor coverage. A UE configured in PLMN access mode may thus not be able to connect to an SNPN that may be available at an enterprise, venue, event, etc. The above may also apply to other types of NPN, such as public network integrated non-public networks (PNI-NPN). While the UE may see available PNI-NPN's within range when in PLMN access mode, the UE may nevertheless see no need to switch to the PNI-NPN when it is connected to the PLMN.

The following describes measures to configure a UE so that the UE is able and configured to switch from a PLMN, to which the UE may be connected to, to an SNPN. Here, the SNPN is, by way of example, operated by or on behalf of an enterprise, with the enterprise having several locations, e.g., in form of offices, warehouses, stores, etc., at which the SNPN is available. It is noted however, that the measures may equally apply to other types of operators, such as event organizers or venue owners, and to other types of NPNs, e.g., PNI-NPNs.

In the example of a SNPN being operated by or on behalf of an enterprise, but also in other examples, a so-called onboarding procedure may be used in which a new UE may be provisioned to use the SNPN. For example, such an onboarding procedure may involve provisioning a new phone for a new employee. In addition to an onboarding procedure, there may also be an offboarding procedure by which access of the UE to the enterprise's SNPN is removed, for example, when an ex-employee hands in their phone on their last working day. At some point after the onboarding procedure and before the offboarding procedure, a provisioning procedure and switching procedure may be carried out, which may be both briefly explained as follows:
1. Provisioning procedure. This procedure may involve an exchange of information between the UE and the SNPN to allow the UE to make an informed decision on when to connect to the SNPN and, where applicable, when to switch the access mode. Such information may comprise the locations of the SNPNs, for example in form of the locations of the SNPNs base stations (which are in the following by way of example gNBs) or any other type of location information indicative of a location of a SNPN, and their configuration. The information pertaining to their configuration may, in particular, comprise the radio frequencies used by the gNBs so as to enable the UE to search for the SNPN. Via this provisioning procedure, internal SNPN information may be shared with the UE but without having to share this information with, for example, the PLMN. This provisioning procedure may be executed after the UE is onboarded.
2. Switching procedure. This procedure may be executed each time a UE determines that it has entered a coverage area of the SNPN, e.g., based on the information supplied during the provisioning phase.

FIG. 5 illustrates these two procedures graphically, showing a provisioning procedure 22 and a switching procedure 23, which may be executed several times. For example, although the provisioning 22 procedure is shown to be performed once in FIG. 5, the provisioning procedure 22 may be implemented as a continuous process and thereby may be executed repeatedly. Also shown are the onboarding procedure 21 and the offboarding procedures 24, both of which are known per se and not further described within this specification.

### Provisioning Procedure

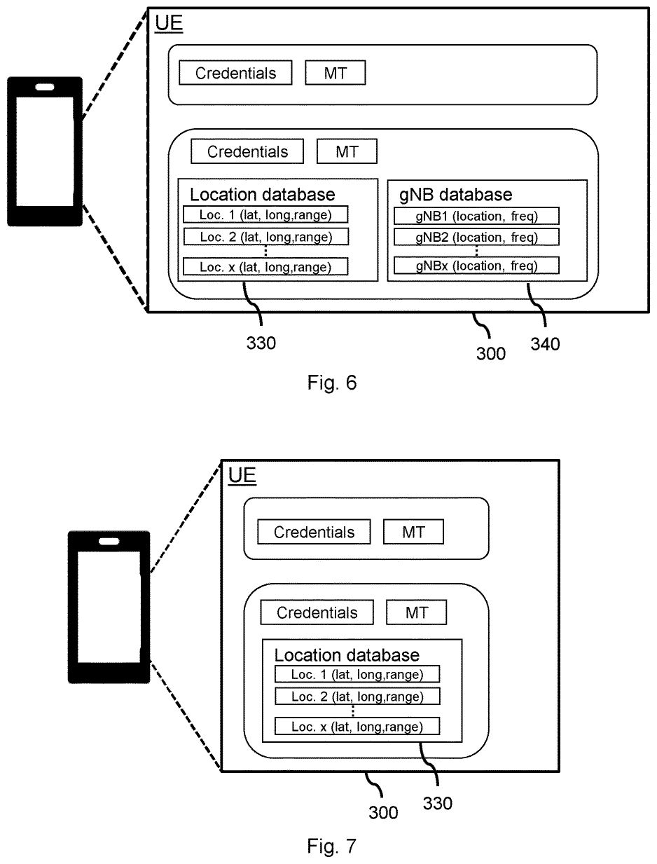

The following provides a more detailed explanation of the provisioning procedure as well as of the configuration of a UE to accommodate the provisioning procedure. For the UE to determine if it is in the vicinity of an enterprise site, or in general, a location at which there is an SNPN, the UE may be configured to locally store location data which is indicative of the SNPN's locations. FIG. 6 shows a first example and FIG. 7 shows a second example of which type of data may be stored by the UE. Although not shown explicitly in FIGS. 6 and 7, the data may for example be stored in the UE's sim card, which may be advantageous since a user can easily change his/her device while retaining the data stored on the sim card if the sim card is transferred to the new device. It will be appreciated, however, that the data may also be stored elsewhere in the UE, e.g., in local volatile or persistent memory. Moreover, reference is again made to an enterprise without this representing a limitation.

FIG. 6 shows a visualization of data stored by the UE 300, which data include two databases, namely a location database 330 and a gNB database 340. The location database 330 may be used to store the locations of the enterprise sites, for example, in form of a latitude (“lat”), a longitude (“long) and a range parameter defining a circle around the location specified by the latitude and the longitude. The UE may be configured to use the location database 330 to determine that it is in the vicinity of an enterprise site. When the UE determines that it is close to an enterprise site, the gNB database 340 may be used. This database may contain at least frequency information, and in some examples also location information, of at least some, if not all, gNBs of the SNPNs at the location the UE is approaching. The UE may be configured to use this database to perform the switching procedure, which in turn will be described in more detail elsewhere in this specification. It will be appreciated, however, that the location information and frequency information stored by the UE may also be stored in a different format other than a database.

FIG. 7 shows the UE 300 storing a location database 330 and not an additional gNB database. This example is an alternative to the FIG. 6 example and requires less data to be stored on the sim card 310 and will be described in more detail elsewhere in this specification. Yet another example, which is neither shown in FIGS. 6, 7, is that the location database and the gNB database may be embodied by one database, which is also explained elsewhere in this specification.

With continued reference to the location information, it is noted that there are several options for specifying a location of a SNPN. Which of these options is used may be determined by the SNPN operator. The options include, but are not limited to:
[latitude, longitude]—a geolocation
[latitude, longitude, radius]—a circular geographical area
multiple [latitude, longitude] points—a geographical area

It is further noted that FIG. 6 and its description refer to a first type of location information, namely location information which is indicative of the approximate coverage area of the SNPN at a particular location, e.g., by defining a geographical circle. It will be appreciated that this first type of location information may in actuality indicate the extent of a venue or an enterprise's premises, but which may be indicative of the coverage area of the SNPN at the particular location as the SNPN is typically optimized to provide coverage across the premises but not much beyond the premises. FIG. 6 also shows a second type of location information which is provided as part of gNB information, namely the locations of gNBs at the location of the venue, enterprise, etc. Since the radio frequencies at which individual gNBs operate at a particular location may differ, the second type of location information may allow the UE to adapt its measurement locally at the location of the SNPN to listen at the radio frequencies of gNBs which are near to the current location of the UE. It will be appreciated that the role of location information as described in this specification may also be fulfilled by the second type of location information, e.g., the locations of gNBs at the venue, enterprise, etc., as this may also provide an indication of the coverage area of the SNPN. In such a case, there may not be a need for a separate location database, but rather one database may provide both location information and frequency information.

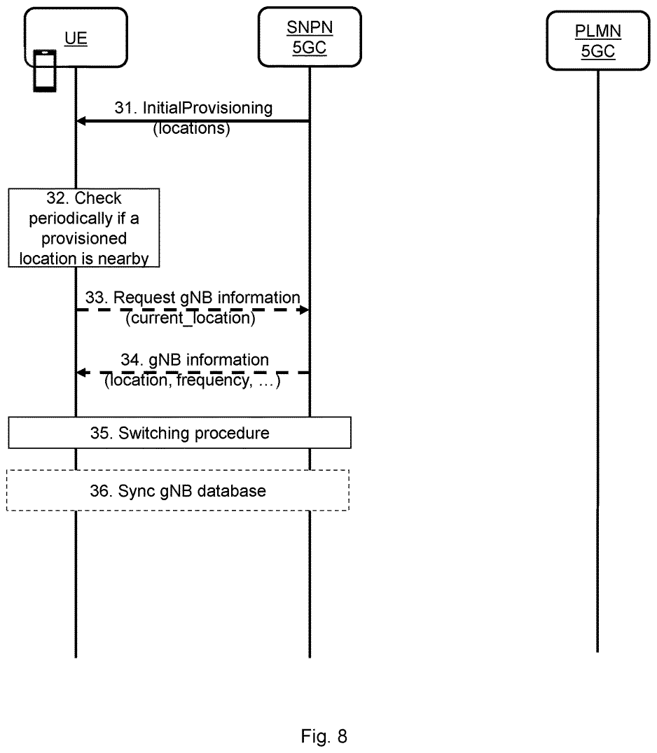

FIG. 8 shows a message exchange for a first example of the provisioning procedure. This provisioning procedure may be performed after an onboarding procedure. At this point in time, the location database of the UE may be empty. The provisioning procedure may be executed as explained below, by which information may be initially stored in the location database and then subsequently kept up-to-date. This way, changes in the network topology may be accommodated, for example when an enterprise opens up another location at which the enterprise's SNPN is available.

In some embodiments, the SNPN's operator may decide to send information about all of its locations and all of its gNBs at each location to the UE to be stored in the database(s). In other embodiments, information for only a subset of the locations and/or a subset of the gNBs per location may be sent and stored at any one point in time. For example, an SNPN operator with a limited number of gNBs but many different locations may choose to send information for all of the gNBs per location but only for a subset of the locations. An example of such an SNPN operator may be a company with many small shops that are spread around the country (e.g., fast food chains, small retail shops, etc.). Another example is an SNPNs operator with only a few locations that service many people (e.g., employees). In this example, the operator may choose to send information for all of the locations but for only a subset of the gNBs per location, for example, the most centrally located gNBs at each location or the outermost gNB(s), for example those located near the boundary of the premises.

The message exchange in the first example of the provisioning procedure is shown in FIG. 8. In this and the following figures, the messages in the figure may be numbered, with the same numbering being used in the accompanying description of the message exchange. Dashed lines may indicate optional or conditional steps. However, it will be appreciated that in this description, the mere reference to certain steps being ‘optional’ does not imply that other steps which are not explicitly labeled as optional are required if they are, in fact, from a technical perspective also optional.
31. ‘InitialProvisioning (locations)’: After the onboarding procedure, the SNPN may send a list of the enterprise's locations to the UE. The UE may update its location database based on this information.
32. ‘Check periodically if a provisioned location is nearby’: If the UE is not connected to the SNPN, the UE may periodically check whether it is within the range of an enterprise location which is identified in the location database.
33. [optional] ‘Request gNB information (current_location)’: If it is nearby an enterprise location, the UE may contact the SNPN, for example via its data connection to the PLMN as explained with reference to FIG. 3. In particular, the UE may request frequency information for the SNPN's gNBs at the enterprise location. This step may be skipped if the gNB database of the UE already stores frequency information for the gNBs at that location. This may for example occur if the UE already visited the enterprise location recently and did not update its gNB database since the last visit.
34. [optional] ‘gNB information (location, frequency)’: The SNPN may send the frequency information, and optionally location information, for the gNB(s) at the location to the UE. The UE may store the frequency information and the optional location information in its gNB database. Such location information may identify the locations of individual gNBs at the enterprise site.
35. ‘Switching procedure’: The UE may execute the switching procedure as explained elsewhere in this specification to connect to the SNPN.
36. ‘Sync gNB database’: The UE may decide to synchronize its gNBs database with the SNPN. This step may be executed if the UE did not execute step 33 due to already having information about the gNBs at that enterprise location. A benefit of synchronizing the gNB database when being connected to the SNPN is that potentially confidential information does not need to be transferred via the PLMN, which may otherwise pose a security risk.

If the switching procedure in step 35 is successful, the UE may be connected and stay connected to the SNPN until it goes out of coverage of the SNPN. The switching procedure may be repeated when and as long as the UE is within range of a location of the SNPN but not yet connected to one of the SNPN's gNBs. Once the UE leaves the coverage area of the SNPN, the UE may reconnect back to the PLMN, which may comprise the UE switching back to the public mobile network access mode. This way, it may be avoided that the UE connects to “malicious” SNPN upon being disconnected from the earlier SNPN, which may otherwise happen if the UE remains in the non-public mobile network access mode and continues searching for SNPNs.

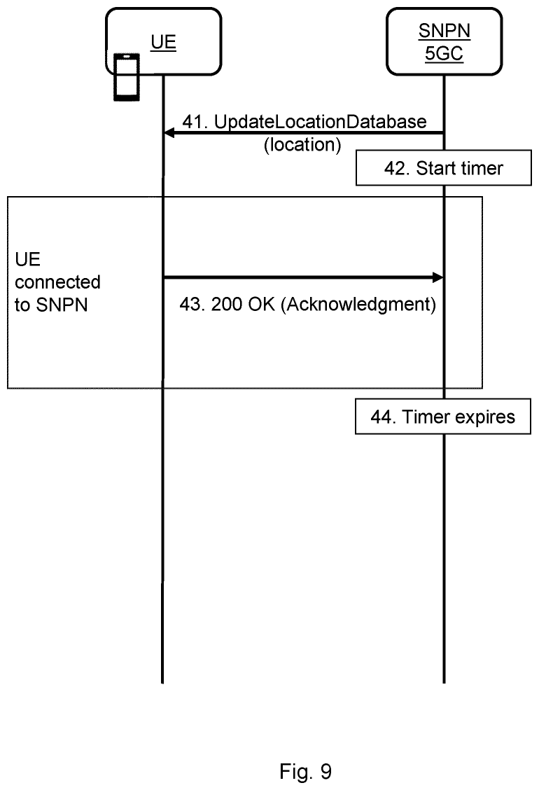

FIG. 9 shows a message exchange which may take place after a change in the SNPN's topology. This may be explained further as follows. If the SNPN changes its topology, e.g., by an enterprise adding a new location and extending the SNPN to the new location or by the SNPN ceasing to operate at a particular location, a UE may be informed of this change by the SNPN and update its location database. In particular, when the SNPN's topology changes, an update to the location information may be broadcast to all UE which may make use of the SNPN, for example with a broadcast message ‘UpdateLocationDatabase (location)’ in step 41 in FIG. 9. Since such changes to the SNPN's topology are expected to occur very infrequently, sending updates of the location information via broadcast messages may be justified. It is noted that alternatively to a broadcast message, individual (e.g., unicast) messages may be sent to the UE. Upon reception of the broadcast message, a UE may acknowledge this update via a ‘200 OK (Acknowledgment)’ message in step 43. In a preceding step 42, the SNPN may start a timer and if no acknowledgment is received from a UE before the expiry of the timer in step 44, the SNPN may again send the updated location information to the UE. It is noted that the FIG. 9 example does show the acknowledgment being received before the expiry of the timer in step 44. It is further noted that FIG. 9 pertains to a change in locations. However, if the change pertains to a change in gNBs at an existing location, for example, an addition or removal of a gNB, only the UE at that location may be informed of this change in the gNBs.

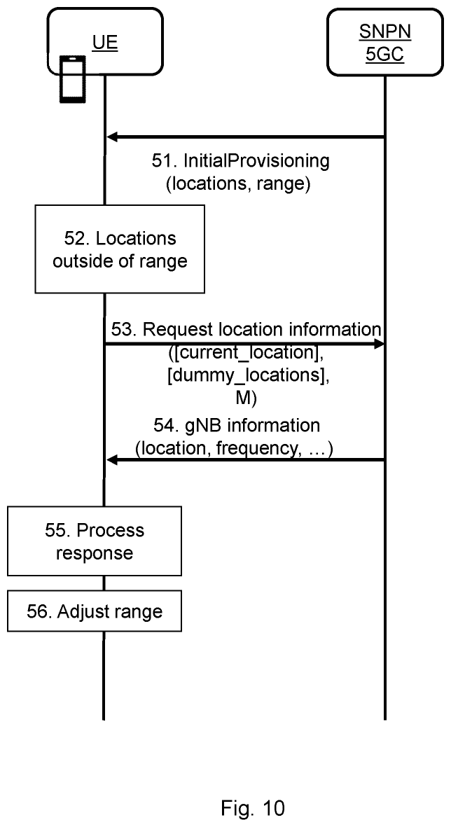

FIG. 10 shows a message exchange for a second example of the provisioning procedure. As in the first example described with reference to FIG. 8, the second example of the provisioning procedure may be performed after an onboarding procedure. The second example pertains to a scenario where the SNPN does not wish to or cannot (e.g., due to memory limitations at the UE) send location information for all the locations of the SNPN to the UE. In this case, the provisioning procedure of FIG. 10 may be used in which a UE may maintain a list of the top-N locations which are nearest to the location of the UE, rather than a list of all of the SNPN's locations. This second example may elsewhere also be referred to as an ‘optimized’provisioning procedure.

The provisioning procedure may comprise the following steps. In the explanation of the steps, continued reference is made to the steps shown in FIG. 8.
51. ‘InitialProvisioning (locations, range)’: The SNPN may, in addition to the location information itself, in which the top-N locations may be identified which are closest to the UE, provide an initial value for a range parameter to the UE. The UE may use this parameter to decide if a provisioned location is out of the reach of the UE. The initial value may be chosen based on, for example, the geographical density of the SNPN's locations. In a specific example, if SNPN's locations are close to each other, a low initial value for the range parameter may be chosen, while otherwise, e.g., if locations are geographically spread out, a high initial value may be chosen.
52. ‘Locations outside of range’: The UE may check, for example, periodically, if any of the locations provisioned in step 51 are outside of the range of the UE, that is, if the distance to a location exceeds the current value of the range parameter. For that purpose, the UE may keep an ordered list of all the locations in which the order may be determined by the distance to its current location. If one or more of the locations are further away from the UE than specified by the range parameter, the UE may proceed to the next step.
53. ‘Request location information ([current_location], [dummy_locations], M)’: The UE may request location and/or frequency information for new locations from the SNPN (FIG. 10 shows the example of location information), for example, directly via the SNPN if the UE is connected to the SNPN or via the PLMN if not connected to the SNPN directly. There may be different options for such a request, for which three examples are given below. It is noted that other options also exist and that a UE may itself decide on which option to use or may combine one or more of the options.
   a. The UE may inform the SNPN of its location and request location and/or frequency information for the M closest enterprise locations. The number M may be the same as the maximum number of locations N stored in the locations database. By selecting M to be equal to the size of the location database, the UE may always be able to fill its location database. Additionally, the UE may include some or all of the currently stored locations in the request so as to enable the SNPN to provide location and frequency information for different locations to the UE. It is noted that this option may reveal the UE's location to the SNPN which may cause privacy concerns.
   b. The UE may request location and/or frequency information for M locations from the SNPN. In addition, in the request, the UE may provide its own location and Y other (e.g., pseudo-randomly chosen) locations. The number M may be chosen to be equal to (Y+1)*N (e.g., N closest locations to the UE, and N closest locations to each random location the UE provided). In this option, the SNPN operator may provide the UE with information on a certain number of locations that are of interest. However, a part of these locations may not be relevant for the UE as they are close to the random locations that the UE supplied to the SNPN rather than to the UE's actual location. An advantage of this option may be that some degree of privacy is provided, as the SNPN operator may only determine that the UE is at one of the locations sent in the request without knowing which one. As in the previous option ‘a’, the UE may include some or all of the currently stored locations in the request. However, these locations may, when sent to the SNPN, indirectly reveal the UE's current location, and therefore cause privacy concerns.
   c. The UE may request location and frequency information for M locations without providing the SNPN with any information on its location. In this option, the SNPN operator may provide the UE with information for M random locations, of which some may be in the vicinity of the UE while others may not. An advantage of this option may be that the SNPN operator may not determine the UE's location at all, or at least not from the request sent by the UE. As in the previous options ‘a’ and ‘b’, the UE may include some or all of the currently stored locations in the request. However, these locations may, when sent to the SNPN, indirectly reveal the UE's current location, and therefore cause privacy concerns.
54. ‘Location information (location, frequency, . . . )’: The SNPN may process the UE's request and, based on which information is provided with the request, proceed with one of the following options:
   a. Provide the UE with M locations that are within the range of locations supplied by the UE. If the location of the UE is specified in the request, the SNPN may prioritize sending location and frequency information for locations that are at a distance smaller than or equal to the value of the range parameter.
   b. Provide the UE with locations that are more or less equally spread to ensure that at least some of them are near to the UE.
55. ‘Process response’: The UE may process the response from the SNPN and may keep the N closest locations in its locations database. If the value M was chosen to be relatively low, or the information received by the UE was not relevant, e.g., for locations already known to the UE or locations that are far away, the UE may decide to repeat step 53. However, repeating step 53 until relevant locations are received from the SNPN may indirectly reveal the UE's current location and therefore cause privacy concerns.
56. ‘Adjust range’: If more than N locations which known to the UE, for example, by being already locally stored in the location database or by being sent by the SNPN in step 54, are within the range specified by the range parameter, the UE may decrease the value of the range parameter, for example, to ensure that the value is equal to the distance to the location stored in the location database that is furthest away. In contrast, if after executing step 53, many locations are outside of the range specified by the range parameter, the UE may decide to increase the value of the range parameter and keep the N closest locations in the location database.

When the UE connects to the SNPN, the UE may synchronize its location database to ensure the location database includes the closest N locations, if these are different from the locations already stored locally by the UE. Since the UE is already connected to the SNPN, the SNPN may already know the UE's location, and hence, there may be lesser or no privacy concerns, for example, as the user is most likely to be at work at a company's location, with this information being already known to the employer.

It is further noted that if the value of the range parameter is selected to be very high or even infinite, the UE may skip the procedure entirely.

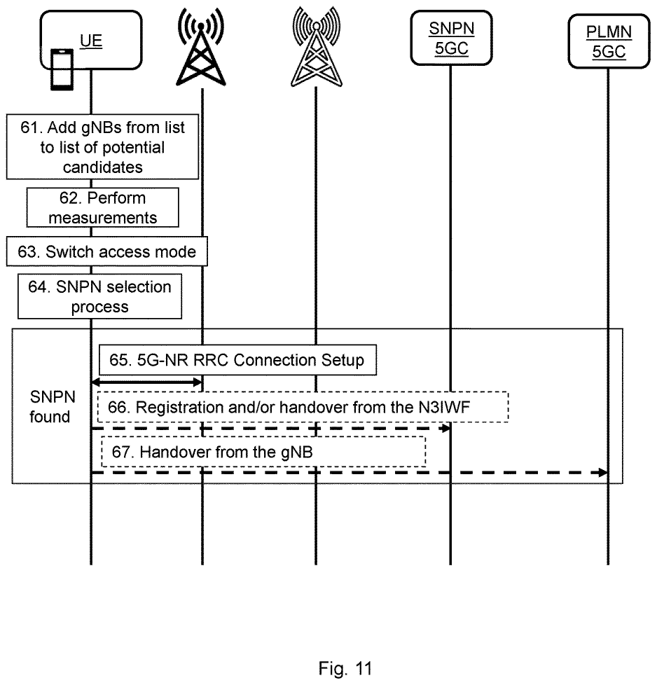

FIG. 11 shows a message exchange in a switching procedure. This switching procedure may involve the following steps:
61. At the UE: ‘Add the gNBs from the gNBs list to the list of potential candidates’. After receiving the list of the gNBs during the provisioning procedure, the UE may be configured to consider the SNPN's cell as a candidate for future use. This is in contrast to the way the SNPN's gNBs would be treated by default in the PLMN access mode.
62. At the UE: ‘Perform specified measurements’. The UE may perform the specified measurement at the radio frequency(-ies) of the SNPN's gNBs, including the gNBs identified in the gNB database and any other gNBs specified in previous radio resource control (RRC) connection reconfiguration messages. Moreover, the UE may use the gNB's locations to optimize this process, e.g., by only measuring the radio frequencies of gNBs close to the current location of the UE.
63. At the UE: ‘Switch access mode’. If any of the SNPN's gNBs have a sufficient signal strength, the UE may switch the access mode from the PLMN access mode to the SNPN access mode.
64. At the UE: ‘SNPN selection process’. The UE may search for available SNPNs in a SNPN selection process.
65. UE to SNPN's gNB: ‘RRC Connection Setup’. If the UE has found the SNPN, the UE may establish a new RRC connection with the SNPN's gNB.
66. [conditional] UE to SNPN's 5GC: ‘Registration and/or N2 Handover from the N3IWF’. A handover of a PDU Session from untrusted non- 3GPP to 3GPP access (3GPP TS 23.502 clause 4.9.2.1) may be performed to ensure the continuity of the PDU session the UE had previously established with the SNPN via PLMN. This step may be executed depending on whether or not the UE was previously connected to the SNPN and was using services from the SNPN. Otherwise, the UE may regularly register with the SNPN. See also FIGS. 3 and 4 and their corresponding description for further details.
67. [conditional] UE to PLMN's 5GC: ‘Handover from the gNB to the N3IWF’. In this step, a handover of a PDU Session from 3GPP to untrusted non-3GPP access (3GPP TS 23.502 clause 4.9.2.2) may be performed to ensure the continuity of the PDU session that the UE has previously established with the PLMN. This step may be executed depending on whether or not the UE wishes to maintain a previous PDU session with the PLMN.

The UE may execute the switching procedure at or near a location of the enterprise, while otherwise, the UE may refrain from executing the switching procedure, e.g., to reduce power consumption associated with the measurements of the SNPN's gNBs. For example, the switching procedure may be executed from when the UE approaches the enterprise's location until the UE is connected to the SNPN at the enterprise's location. After the UE moves out of the coverage area of the SNPN, the UE may switch access mode to the PLMN access mode and reconnect to the PLMN.

The following continues to refer to the provisioning procedure and the switching procedure but describes various steps from the perspective of a respective entity (e.g., UE, SNPN, PLMN, etc.) while referring to the respective procedure. It is noted that the numbering of steps is here independent of the numbering used in the figures. It is further noted that the procedure described with reference to FIG. 9 is omitted, but its steps may be executed anytime between the steps mentioned below.

User equipment: the UE may perform one or more of the following steps:
1. (Provisioning procedure) After onboarding, the UE may receive the initial list of the enterprise's locations from the SNPN and store this list in its location database.
   a. Optionally, the SNPN may specify an initial value for a range parameter to be used by the UE.
2. [optional] (Optimized provisioning procedure) The UE may monitor its distance to each provisioned location. If one or more of these locations exceed the distance specified by the range parameter, the UE may request information for new locations from the SNPN. Multiple strategies may be applied and may depend on the privacy settings of the UE. See also FIG. 10 and its corresponding description.
3. [optional] (Optimized provisioning procedure) The UE may receive location and frequency information for the new locations from the SNPN. The UE may keep the N closest locations in its locations database. If the number of locations was chosen to be relatively low, or if the information received by the UE was not relevant, e.g., for locations already known to the UE or locations that are far away, the UE may decide to repeat step 2.
4. [optional] (Optimized provisioning procedure) If needed, the UE may adjust the value of the range parameter based on the newly supplied locations.
5. [optional] (Provisioning procedure) If the UE detects that it is within the range of an enterprise location identified in the location database, the UE may contact the SNPN, e.g., via the PLMN, to request a list of the company's gNBs at the location it is approaching. This step can be skipped if the UE already contains the radio frequencies of the gNBs of that location in its gNBs database. This may, for example, be the case if the UE has previously already visited the enterprise location.
6. [optional] (Provisioning procedure) The UE may receive frequency information for the gNBs from the SNPN and save the frequency information in its gNB database. This step may be performed if step 5 was performed.
7. (Switching procedure) The UE may add the gNBs from the list of gNBs to its list of potential cell candidates. Moreover, the UE may use the gNB's locations to optimize this process, e.g., by only measuring the radio frequencies of gNBs close to the current location of the UE.
8. (Switching procedure) The UE may perform the specified measurement at the radio frequency(-ies) of the SNPN's gNBs.
9. (Switching procedure) If any of the SNPN's gNBs have a sufficient signal strength, the UE may switch the access mode from the PLMN access mode to the SNPN access mode.
10. (Switching procedure) The UE may search for available SNPNs.
11. (Switching procedure) The UE may connect to the SNPN, which may optionally comprise a handover as in steps 66 and 67 of FIG. 10.

SNPN: the SNPN may perform one or more of the following steps:
1. (Provisioning procedure) After the onboarding procedure, the SNPN may send a list of the enterprise's locations to the UE.
   a. If an optimized provisioning procedure is used, the SNPN may provide an initial value for a range parameter to the UE.
2. (Optimized provisioning procedure) If the SNPN receives a request for new locations from a UE, the SNPN may return a list of these locations to the UE. The list may be comprised of locations which may be selected by the SNPN in a manner as described elsewhere in this specification.
3. (Provisioning procedure) If the SNPN receives a request for frequency information of gNBs at a certain location, the SNPN may return such frequency information to the requesting UE.
4. (Switching procedure) The SNPN may process a registration request from the UE. If the UE connects via the 3GPP access and a PDU session with the SNPN was already established, the SNPN may execute a handover of the PDU session from the non-3GPP access to the 3GPP access.

PLMN: the PLMN may perform one or more of the following steps:

The PLMN may be involved in a later or last step of the switching procedure in which the UE may choose to handover its existing PLMN PDU session from 3GPP to untrusted non-3GPP access (via the N3IWF). This step may be executed if this is allowed by the SNPN, e.g., if there is a connection between the SNPN and the PLMN.

It will be appreciated that enabling the user equipment to connect to a non-public mobile network may also take other forms or comprise additional steps.

For example, if the number of locations of the SNPN is very limited, for example, being only one, the SNPN may choose to provision only the gNB database in the UE and omit the location database. Corresponding steps relating to the location database may therefore be omitted from the provisioning procedure.

With continued reference to FIG. 6, the SNPN may choose to split the gNB database to contain information for two (or more) locations. This way, the UE may maintain the frequency information of gNBs from the last two locations it visited. This may be used to reduce the number of times the UE may contact the SNPN while not connected to the SNPN's gNBs and, consequently, the traffic sent over the PLMN.

In general, the functionality described in this specification which is attributed to a system or network (e.g., the SNPN or the PLMN) may represent functionality of one or more network functions which are implemented in the respective mobile network, e.g., by a network node or a system of network nodes. The network function(s) may be made available within the respective mobile network so as to establish the respective functionality in the respective mobile network.

It will be appreciated that according to prior art standards (e.g., 3GPP TS 23.501 Clause 5.30.2.4.1, 3GPP TS 23.122 Clause 4.4.1), SNPN and PLMN access modes in a UE may be mutually exclusive. Hence, a UE operating in SNPN access mode may select stand-alone Non-Public Networks (SNPNs) over the Uu interface and may not perform the PLMN selection process. Similarly, if a UE is not set to operate in SNPN access mode, even if it is SNPN-enabled, the UE may not select and register with SNPNs. The same reasoning may apply to PLMN access mode, e.g., a UE operating in PLMN access mode may not select and register with SNPNs, but only to available PLMNs. As a consequence, while a prior art UE (operating in SNPN mode and registered to an SNPN) may register with a PLMN via the SNPN (where the SNPN is acting as an Untrusted non-3GPP access, see 3GPP TS 23.501 Clause 5.30.2.7), the UE may not switch to the PLMNs NG-RAN if out of range of the SNPN since the UE may be operating in the SNPN access mode. To address this deficiency, the UE may be configured to autonomously switch access mode if the measurement (e.g., step 63 in FIG. 11) indicates that a switch to the SNPN is possible.

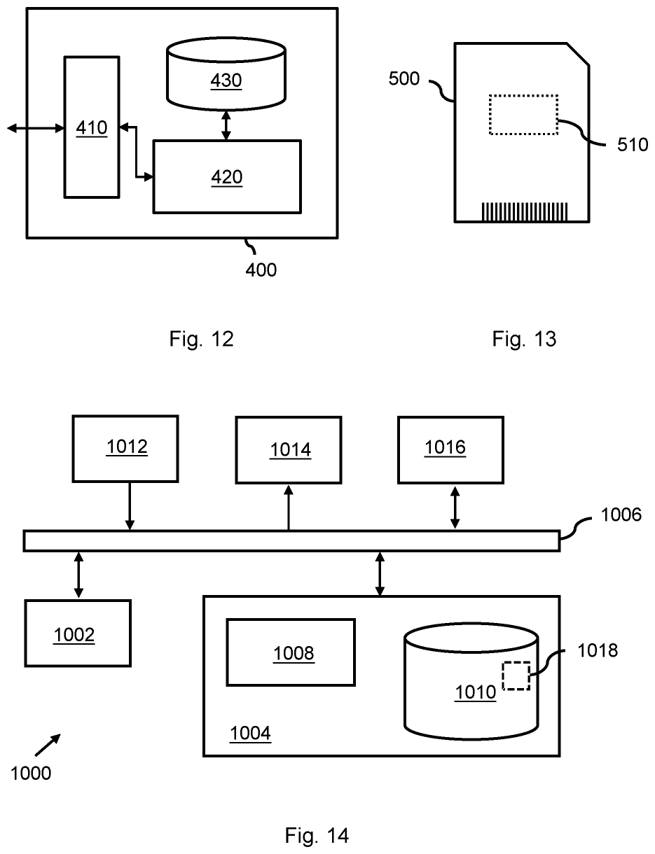

FIG. 12 shows a system 400 which may represent a system configured to enable user equipment to connect to a non-public mobile network as described in this specification, meaning that the system 400 may implement such system. The system 400 may comprise a network interface 410 for network data communication. The network interface 410 may for example be a wired communication interface, such as an Ethernet or fiber-optic based interface, to a fixed (e.g., non-mobile) part of a mobile telecommunications network. Alternatively, the network interface 410 may be a wireless communication interface. In yet other examples, the system 400 may be a subsystem of a larger system, e.g., a supra-system implementing several network functions. In such cases, the network interface 410 may be an internal interface of the supra-system, for example a virtual, software-based network interface. The system 400 may further comprise a processor subsystem 420 which may be configured, e.g., by hardware design or software, to perform the operations described in this specification in as far as pertaining to the entity that the processor system is embodying, e.g., the aforementioned system configured to enable user equipment to connect to a non-public mobile network. In particular, the processor subsystem 420 may be configured to perform the actions attributed to the SNPN as described with reference to FIGS. 5-11.

In general, the processor subsystem 420 may be embodied by a single Central Processing Unit (CPU), such as a x86 or ARM-based CPU, but also by a combination or system of such CPUs and/or other types of processing units. In embodiments where the system 400 is distributed over different entities, e.g., over different servers, the processor subsystem 420 may also be distributed, e.g., over the CPUs of such different servers. As also shown in FIG. 12, the system 400 may comprise a data storage 430, such as a hard drive, a solid-state drive, or an array of such hard and/or solid-state drives, etc., which may be used to store data. In some examples, the system 400 may be implemented by a network node, or by a system of network nodes.

In an alternative embodiment of the system 400 of FIG. 12, the system 400 may represent user equipment, or a device representing user equipment, as described in this specification. An example of such a device includes, but is not limited to, a mobile phone, a tablet device, a computer, a pair of smart glasses, or an IoT device such as a robot, a connectivity enabled vehicle, etc. In such cases, the network interface 410 may represent a radio access network interface to a mobile network, and the processor subsystem 420 may be configured, e.g., by hardware design or software, to perform the operations described in this specification in as far as pertaining to the entity that the processor system is embodying, e.g., the user equipment or the device.

In general, each entity described in this specification may be embodied as, or in, a device or apparatus. The device or apparatus may comprise one or more (micro)processors which execute appropriate software. The processor(s) of a respective entity may be embodied by one or more of these (micro)processors. Software implementing the functionality of a respective entity may have been downloaded and/or stored in a corresponding memory or memories, e.g., in volatile memory such as RAM or in non-volatile memory such as Flash. Alternatively, the processor(s) of a respective entity may be implemented in the device or apparatus in the form of programmable logic, e.g., as a Field-Programmable Gate Array (FPGA). Any input and/or output interfaces may be implemented by respective interfaces of the device or apparatus. In general, each functional unit of a respective entity may be implemented in the form of a circuit or circuitry. A respective entity may also be implemented in a distributed manner, e.g., involving different devices or apparatus.

It is noted that any of the methods described in this specification, for example in any of the claims, may be implemented on a computer as a computer implemented method, as dedicated hardware, or as a combination of both. Instructions for the computer, e.g., executable code, may be stored on a computer-readable medium 500 as for example shown in FIG. 13, e.g., in the form of a series 510 of machine-readable physical marks and/or as a series of elements having different electrical, e.g., magnetic, or optical properties or values. The executable code may be stored in a transitory or non-transitory manner. Examples of computer-readable mediums include memory devices, optical storage devices, integrated circuits, servers, online software, etc. FIG. 13 shows by way of example a memory card 500.

FIG. 14 is a block diagram illustrating an exemplary data processing system 1000 that may be used in the embodiments described in this specification. Such data processing systems include data processing entities described in this specification, including but not limited to a system configured to enable user equipment to connect to a non-public mobile network. The data processing system 1000 may include at least one processor 1002 coupled to memory elements 1004 through a system bus 1006. As such, the data processing system may store program code within memory elements 1004. Furthermore, processor 1002 may execute the program code accessed from memory elements 1004 via system bus 1006. In one aspect, data processing system may be implemented as a computer that is suitable for storing and/or executing program code. It should be appreciated, however, that data processing system 1000 may be implemented in the form of any system including a processor and memory that is capable of performing the functions described within this specification. The memory elements 1004 may include one or more physical memory devices such as, for example, local memory 1008 and one or more bulk storage devices 1010. Local memory may refer to random access memory or other non-persistent memory device(s) generally used during actual execution of the program code. A bulk storage device may be implemented as a hard drive, solid state disk or other persistent data storage device. The data processing system 1000 may also include one or more cache memories (not shown) that provide temporary storage of at least some program code in order to reduce the number of times program code is otherwise retrieved from bulk storage device 1010 during execution.

Input/output (I/O) devices depicted as input device 1012 and output device 1014 optionally can be coupled to the data processing system. Examples of input devices may include, but are not limited to, for example, a microphone, a keyboard, a pointing device such as a mouse, a game controller, a Bluetooth controller, a VR controller, and a gesture-based input device, or the like. Examples of output devices may include, but are not limited to, for example, a monitor or display, speakers, or the like. Input device and/or output device may be coupled to data processing system either directly or through intervening I/O controllers. A network adapter 1016 may also be coupled to data processing system to enable it to become coupled to other systems, computer systems, remote network devices, and/or remote storage devices through intervening non-public or public networks. The network adapter may comprise a data receiver for receiving data that is transmitted by said systems, devices and/or networks to said data and a data transmitter for transmitting data to said systems, devices and/or networks. Radios, modems, cable modems, and ethernet cards are examples of different types of network adapter that may be used with data processing system 1000.

As shown in FIG. 14, memory elements 1004 may store an application 1018. It should be appreciated that data processing system 1000 may further execute an operating system (not shown) that can facilitate execution of the application. The application, being implemented in the form of executable program code, can be executed by data processing system 1000, e.g., by processor 1002. Responsive to executing the application, the data processing system may be configured to perform one or more operations to be described herein in further detail.

For example, data processing system 1000 may represent a system configured to enable user equipment to connect to a non-public mobile network as described in this specification. In that case, application 1018 may represent an application that, when executed, configures data processing system 1000 to perform the functions described with reference to the system. In another example, data processing system 1000 may represent an embodiment of user equipment or a device representing user equipment as described in this specification. In that case, application 1018 may represent an application that, when executed, configures data processing system 1000 to perform the functions described with reference to the user equipment and/or device.

An abstract for the present specification may read as follows: A device, system and methods are described to enable the device, which may represent user equipment for a mobile network, to make use of a non-public mobile network which may be available at one or more locations. The device may be provided with location information which identifies the locations at which the non-public mobile network is available and with frequency information for at least one of the one or more locations. The device may be configured to use the location information to determine if the device is at or within a vicinity of one of the locations, and if so, perform measurements at radio frequencies indicated by the frequency information. As the coverage area of the non-public network may be relatively sparse, this may avoid the inefficiencies of a continuous or periodic search for non-public networks, which may otherwise place a burden on compute, battery and/or radio resources of the UE.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or stages other than those stated in a claim. The article “a” or “an” preceding an element does not exclude the presence of a plurality of such elements. Expressions such as “at least one of” when preceding a list or group of elements represent a selection of all or of any subset of elements from the list or group. For example, the expression, “at least one of A, B, and C” should be understood as including only A, only B, only C, both A and B, both A and C, both B and C, or all of A, B, and C. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A device representing user equipment for a mobile network, wherein the device comprises:
a radio access network interface;
a processor subsystem configured to:
receive location information which identifies one or more locations at which a non-public mobile network is available;
receive frequency information for at least one of the one or more locations, wherein the frequency information for a location is indicative of one or more radio frequencies used by the non-public mobile network at the location;
wherein the processor subsystem is further configured to:
using the location information, determine if the device is at or within a vicinity of the location; and
if the device is at or within the vicinity of the location, perform measurements at the one or more radio frequencies indicated by the frequency information to enable the device to connect to the non-public mobile network if the measurements indicate that a connection to the non-public mobile network is possible.

2. The device according to claim 1, wherein the processor subsystem is configured to, after receiving the location information, request the frequency information from an entity within the non-public mobile network.

3. The device according to claim 2, wherein the processor subsystem is configured to request the frequency information if the device is, or is expected to be, at or within the vicinity of the location.

4. The device according to claim 1, wherein the processor subsystem is configured to request the location information from an entity within the non-public mobile network.

5. The device according to claim 4, wherein the processor subsystem is configured to include at least one geolocation in the request for the location information, wherein the least one geolocation comprises at least one of:
a current geolocation of the device;
an expected geolocation of the device; and
a combination of the current geolocation or the planned geolocation of the device and one or more geolocations which are selected by the processor subsystem not to represent a geolocation of the device, for example one or more pseudo-randomly selected geolocations.

6. The device according to claim 4, wherein the processor subsystem is configured to indicate, in the request for the location information, how many locations of the non-public mobile network, which are nearest to a respective geolocation from the request for the location information, are to be identified in the location information.

7. The device according to claim 1, wherein the processor subsystem is configured to determine whether the device is outside a range of the one or more locations identified in the location information, and if it is determined that the device is outside the range, request further location information of one or more further locations of the non-public mobile network, for example which are nearer to the device.

8. The device according to claim 1, wherein the processor subsystem is configured to receive the location information, receive the frequency information, and/or send respective requests to an entity within the non-public mobile network, via a public mobile network.

9. A system configured to enable user equipment to connect to a non-public mobile network, wherein the system is part of the non-public mobile network, wherein the system comprises:
a network interface;
a processor subsystem configured to, via the network interface:
send location information to the user equipment, wherein the location information identifies one or more locations at which the non-public mobile network is available; and
send frequency information for at least one of the one or more locations to the user equipment, wherein the frequency information for a location is indicative of one or more radio frequencies used by the non-public mobile network at the location.

10. The system according to claim 9, wherein the processor subsystem is configured to send the frequency information to the user equipment in response to a request for the frequency information which is received from the user equipment.

11. The system according to claim 10, wherein the location information identifies a plurality of locations of the non-public mobile network, wherein the request for the frequency information identifies one or a subset of the plurality of locations, and wherein the processor subsystem is configured to selectively send the frequency information for the one or the subset of locations.

12. The system according to claim 9, wherein the processor subsystem is configured to send the location information to the user equipment in response to a request for the location information which is received from the user equipment.

13. The system according to claim 12, wherein the request for the location information comprises at least one geolocation, and wherein the processor subsystem is configured to send the location information for one or more locations of the non-public mobile network, wherein the one or more locations are selected based on the at least one geolocation, for example based on whether a respective location is within a vicinity of the at least one geolocation.

14. The system according to claim 9, wherein the location information identifies the location of the non-public mobile network by at least one of:
a geolocation defined by a latitude and a longitude;
a geographical area defined by a latitude, longitude, and radius;
a geographical area defined by a plurality of geolocations; and
an identifier of one or more base stations of the public network at the location of the non-public mobile network.

15. The system according to claim 9, wherein the processor subsystem is configured to send the location information and/or the frequency information to the user equipment via a public mobile network, for example via a non-3GPP Inter-Working Function (N3IWF) of the non-public mobile network.

16. A mobile network comprising the system according to claim 8.

17. A computer-implemented method for being performed by a device which represents user equipment for a mobile network, wherein the method comprises, by the device:
receiving location information which identifies one or more locations at which a non-public mobile network is available;
receiving frequency information for at least one of the one or more locations, wherein the frequency information for a location is indicative of one or more radio frequencies used by the non-public mobile network at the location;
using the location information, determining if the device is at or within a vicinity of the location; and
if the device is at or within the vicinity of the location, performing measurements at the one or more radio frequencies indicated by the frequency information to enable the device to connect to the non-public mobile network if the measurements indicate that a connection to the non-public mobile network is possible.

18. A computer-implemented method for enabling user equipment to connect to a non-public mobile network, wherein the method comprises, by a system which is part of the non-public mobile network:
sending location information to the user equipment, wherein the location information identifies one or more locations at which the non-public mobile network is available; and
sending frequency information for at least one of the one or more locations to the user equipment, wherein the frequency information for a location is indicative of one or more radio frequencies used by the non-public mobile network at the location.

19. A transitory or non-transitory computer-readable medium comprising data representing a computer program, the computer program comprising instructions for causing a processor system to perform the method according to claim 17.
